(19) United States
(12) Patent Application Publication
(10) Pub. No.: US 2014/0323162 A1
(43) Pub. Date: Oct. 30, 2014

(54) SYSTEM AND METHOD FOR GENERATING A POSITIONING MAP OF TWO OR MORE MOBILE DEVICES ACCORDING TO RELATIVE LOCATIONS

(71) Applicants: Ran GILADI, (US); Shai SAUL, (US)

(72) Inventors: Ehud EZRA, Mevaseret Zlon (IL); Ofer SIMON, Jerusalem (IL)

(73) Assignees: Shai SAUL, Tel Aviv (IL); Ran GILADI, Omer (IL)

(21) Appl. No.: 13/869,993

(22) Filed: Apr. 25, 2013

(51) Int. Cl. H04W 4/02; G01S 5/02

(52) U.S. Cl. CPC H04W 4/026; G01S 5/0284
USPC 455/457

(57) ABSTRACT

The subject matter discloses a method performed on two or more mobile devices comprising obtaining a magnetic azimuth value of a mobile device of the two or more mobile devices; obtaining a physical orientation value of the mobile device of the two or more mobile devices; broadcasting the magnetic azimuth value and the physical orientation value from the mobile device, wherein each mobile device of the two or more mobile devices are broadcasting the magnetic azimuth value and the physical orientation value to another mobile device of the two or more mobile devices; receiving the magnetic azimuth value and the physical orientation value, wherein each mobile device of the two or more mobile devices receives the magnetic azimuth value and the physical orientation value of other mobile devices of the two or more mobile devices; determining a relative location of the two or more mobile devices, according to the magnetic azimuth value and the physical orientation value of each mobile device of the two or more mobile devices; generating a positioning map of the two or more mobile devices, wherein the positioning map comprises relative locations of the two or more mobile devices.

### FIELD OF THE INVENTION

The subject matter relates generally to generating a positioning map of two or more mobile devices through obtaining a relative location of each mobile device of the two or more mobile devices.

### BACKGROUND OF THE INVENTION

The connection of mobile devices requires at least one mobile device suitable for the detection of signals from mobile devices in the chosen area detecting said signals counting of the number of different signals detected optionally saving the information on the number of signals counted on a device for data storage. Some manners of connecting mobile devices are through audio signals. The mobile devices determining location of other mobile devices through time differences between detection of the start and end signals of the other mobile device that are generally best aligned with the direction in which the mobile devices are detecting other mobile devices.

### SUMMARY

It is an object of the subject matter to disclose a method performed on two or more mobile devices comprising obtaining a magnetic azimuth value of a mobile device of the two or more mobile devices; obtaining a physical orientation value of the mobile device of the two or more mobile devices; broadcasting the magnetic azimuth value and the physical orientation value from the mobile device, wherein each mobile device of the two or more mobile devices are broadcasting the magnetic azimuth value and the physical orientation value to another mobile device of the two or more mobile devices; receiving the magnetic azimuth value and the physical orientation value, wherein each mobile device of the two or more mobile devices receives the magnetic azimuth value and the physical orientation value of other mobile devices of the two or more mobile devices; determining a relative location of the two or more mobile devices, according to the magnetic azimuth value and the physical orientation value of each mobile device of the two or more mobile devices; generating a positioning map of the two or more mobile devices, wherein the positioning map comprises relative locations of the two or more mobile devices.

In some cases, each mobile device of the two or more mobile devices creates the positioning map and stores the positioning map.

In some cases, the method further comprises determining whether two mobile devices of the two or more mobile devices are positioned in parallel configuration when broadcasting position data; transmitting a message to the two mobile devices that requests the two mobile devices be moved in opposite directions and rebroadcast the position data; and, updating the positioning map.

In some cases, the method further comprises determining whether two mobile devices of the two or more mobile devices are positioned in parallel configuration when broadcasting position data; receiving an image from each mobile device of the two mobile devices; determining the relative location according to overlapping portions of images received from the two mobile devices; and, updating the positioning map.

In some cases, the method further comprises determining whether two mobile devices of the two or more mobile devices are positioned in parallel configuration when broadcasting position data; receiving a user command designating a right mobile device and a left mobile device.

In some cases, the method further comprises determining whether three mobile devices are parallel when broadcasting position data; determining position data of a left mobile device; determining the position data of a right mobile device; determining a central mobile device according to the position data of the right mobile device and the left mobile device; and, updating the positioning map.

In some case, the method further comprises selecting a host mobile device, wherein all communication between the two or more mobile devices is performed through a host. In some cases, the two or more mobile devices are pointing towards a central region.

It is another object of the subject matter to disclose a method performed on two or more mobile devices comprising broadcasting a signal by a mobile device of the two or more mobile devices; determining a distance between the mobile device and other mobile device of two or more mobile device; detecting that a second mobile device of the two or more mobile devices performed a movement and a movement direction; broadcasting a second signal to the second mobile device of the two or more mobile devices; determining a new distance between the mobile device and other mobile device of the two or more mobile device; determining a relative location of the second mobile device of the two or more mobile devices, where the relative location is determined by the movement direction and a distance difference between the new distance and the distance; generating a positioning map, wherein the positioning map comprises relative locations of the two or more mobile devices.

In some cases, the method further comprises receiving a time-mark from the second mobile device of the two or more mobile devices, wherein said time-mark is a time the second mobile device of the two or more mobile devices received the signal; receiving a second time-mark from the second mobile device of the two or more mobile devices, wherein said second time-mark is the time the second mobile device of the two or more mobile devices received the second signal.

In some cases, the method further comprises determining a signal amplitude of the signal to determine the distance; determining a second signal amplitude;

In some cases, the method is performed on a host. In some cases, each mobile device of the two or more mobile devices creates the positioning map and stores the positioning map. In some cases, the relative location comprises magnetic azimuth values and proper acceleration values. In some cases, the signal is as an audio signal emitted by a speaker of the mobile device of the two or more mobile devices.

In some cases, the method further comprises determining a global position of the mobile device; broadcasting the global position to the other mobile devices; determining the global positions of each mobile device of the other mobile devices, wherein the global positions are determined from the relative location and global position of the mobile device; receiving the global positions from the other mobile devices.

It is another object of the subject matter to disclose a system on a mobile device that comprises a display; a detection unit; a processor to determine a position data of the mobile device, wherein the position data is determined according to a magnetic azimuth value and proper acceleration, wherein the processor determines a physical orientation value of the mobile device; a mapping unit to create a positioning map according to the position data determined by the processor and the position data received by a transceiver, wherein the position data received by the transceiver is received from other mobile devices; a storage to store the positioning map created by the mapping unit, wherein the position data is received from the other mobile devices connected to the mobile device.

In some cases, the detection unit comprises an accelerometer to collect the proper acceleration; a magnetometer to collect the magnetic azimuth value of the mobile device. In some cases the display displays the positioning map and threshold of mobile devices connected to the mobile device.

In some cases, the system further comprises a speaker to broadcast a signal; a microphone for collecting the signal broadcasted by the other mobile devices.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system on a mobile device for determining a relative location and creating a positioning map, according to some exemplary embodiments of the subject matter;

FIG. 2 shows a method performed on two or more mobile devices to generate a positioning map disclosing relative locations of the two or more mobile devices that are directed towards a central region, according to some exemplary embodiments of the subject matter;

FIG. 3A shows a method performed on a mobile device to determine a magnetic azimuth value of the mobile device where there is magnetic interference, according to some exemplary embodiments of the subject matter;

FIG. 3B shows a method performed on a mobile device for testing location threshold of one or more other mobile devices, according to some exemplary embodiments of the subject matter;

FIG. 4 shows a static configuration of mobile devices around a central region, according to some exemplary embodiments of the subject matter;

FIG. 5A-5E show configurations of mobile devices on a positioning map, according to some exemplary embodiments of the subject matter;

FIG. 6 shows a dynamic configuration of mobile devices, according to exemplary embodiments of the subject matter;

FIG. 7 shows a database on a mobile device for dynamically connecting with other mobile devices, according to some exemplary embodiments of the subject matter;

FIG. 8 shows a method performed on two or more mobile devices to generate a positioning map disclosing relative locations of the two or more mobile devices that are moving, according to exemplary embodiments of the subject matter; and,

FIGS. 9A-9C show determining position data of mobile device B relative to mobile device A on a cardinal points axis system, according to some exemplary embodiments of the subject matter.

### DETAILED DESCRIPTION

The subject matter discloses a system and method of generating a positioning map of two or more mobile devices through obtaining a relative location of each mobile device of the two or more mobile devices, according to some exemplary embodiments of the subject matter. The system and method enables to determine a relative location between at least two of the two or more mobile devices according to position data. The system and method of the disclosed subject matter may use the position data obtained from a magnetometer, accelerometer, gyroscope or the like. In some cases, the position data of a mobile device of the two or more mobile device comprises a physical orientation value and a magnetic azimuth value of the mobile device. The system and method require that the two or more mobile devices are enabled to transmit and receive magnetic azimuth values, for example through Bluetooth, WiFi, or the like.

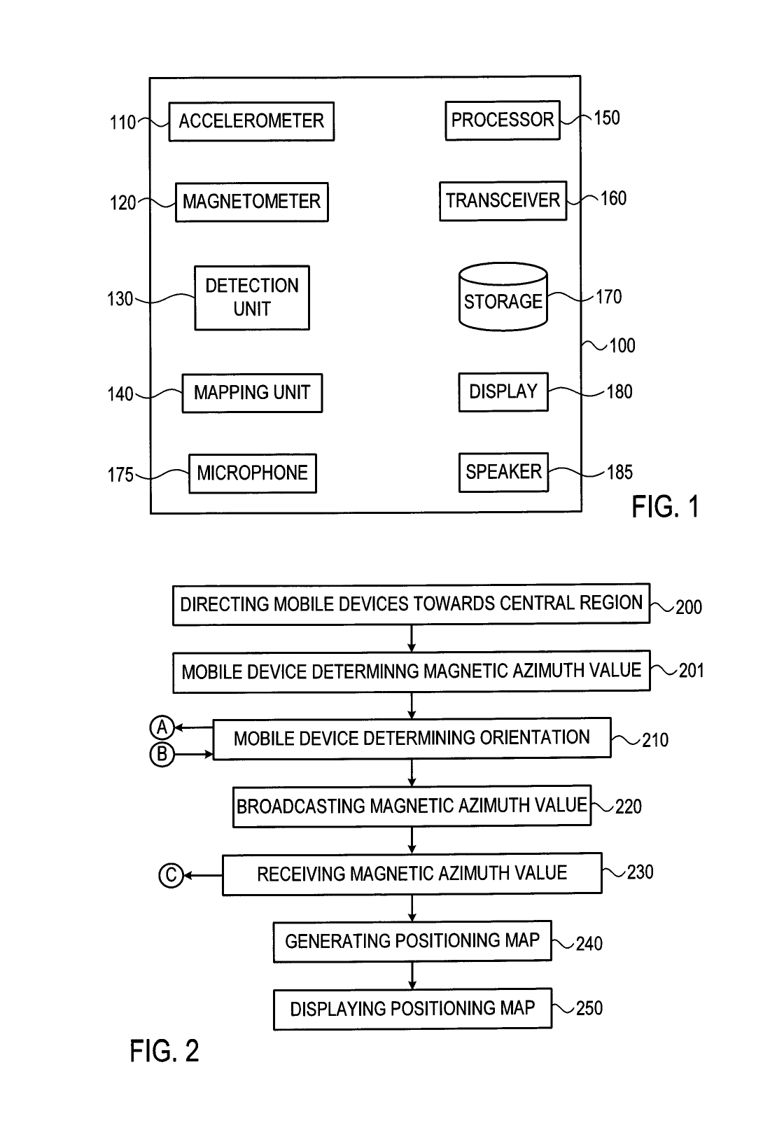

FIG. 1 shows a system on a mobile device for creating a positioning map and transmitting data to other mobile devices, according to some exemplary embodiments of the subject matter. The mobile device 100 is one of the two or more mobile devices connected to each other and transfer data there between. The mobile device 100 comprises an accelerometer 110, which is used to collect a proper acceleration, i.e. detecting an acceleration of the mobile device 100 when the mobile device 100 is moved in some direction. In some exemplary cases, the accelerometer 110 may be used in tandem with a gyroscope (not shown) to collect data regarding the orientation of the mobile device 100. In other exemplary cases, the accelerometer 110 and the gyroscope function in tandem to collect more accurate orientation data. The orientation data is transferred to a processor 150, which determines the proper acceleration or orientation of the mobile device 100.

The mobile device 100 further comprises a magnetometer 120, which is used to collect a magnetic azimuth value of the mobile device 100. The magnetometer 120 collects a three dimensional magnetic value of the mobile device 100, which is used to calculate a magnetic azimuth value by the processor 150. The magnetic azimuth value and proper acceleration determined by the processor 150 enable the processor 150 to determine relative location. The relative location is determined differently according to whether the mobile device 100's location is static or dynamic. In cases where the mobile device 100 is static, the relative location of the mobile device 100 is an angle of the mobile device 100 relative to a central region. In cases where the location of the mobile device 100 is dynamic, the relative location is the location of the mobile device 100 relative to other mobile devices with respect to the movement and distance of the mobile device 100 from the other mobile devices. The magnetic azimuth value and physical orientation value of the mobile device 100 is broadcasted by a transceiver 160 to a host or to other mobile devices of the two or more mobile devices with which all communication between the two or more mobile devices is performed through a host device 100 is attempting to connect. In some cases, the mobile device 100 is designated to be a host mobile device, which is one of the mobile devices being connected together and all communications. The transceiver 160 receives positioning data, such as magnetic azimuth values, which are broadcasted by other mobile devices of the two or more mobile devices that are attempting to connect to the mobile device 100. The positioning data received by the transceiver 160 enables the mobile device 100 to determine the relative locations of the two or more mobile devices and to generate a positioning map. In some exemplary embodiments of the subject matter, the transceiver 160 may use Bluetooth, Wi-Fi, or the like. The transceiver 160 is used to transfer and receive data between the mobile device 100 and the other mobile devices, for example media files, documents, play a multiplayer game, e-mails, texts, web links, YouTube films, and the like.

The mobile device 100 comprises a detection unit 130, which is used to detect commands performed by the user of the mobile device 100 to input commands to the mobile device 100. For example, the command may be to transfer data to another mobile device of the two or more mobile devices. In some cases, the detection unit 130 may be a touchscreen or a graphic user interface. The command may be inputted by the user using a finger to create a movement on the screen, such as a sliding gesture. In some cases the movement may be to designate a file to be sent to a target mobile device. The user then drags or slides the file across the graphic user interface of the mobile device to the target mobile device to transfer the file to the receiving mobile device. In some exemplary embodiments of the subject matter, the detection unit 130, may comprise the accelerometer 110, the magnetometer 120, the gyroscope or a combination thereof.

The mobile device 100 comprises a mapping unit 140, which generates the positioning map according to the positioning data obtained by the magnetometer 120 and the accelerometer 110, and the data received by the transceiver 160. Using the positioning data received by the transceiver 160 from the other mobile devices, the mobile device 100 determines locations of the other mobile devices relative to the location of the mobile device 100. The mapping unit 140 transmits the positioning map to a display 180 to display the positioning map and the data required to the user to transfer data to another mobile device displayed on the positioning map. In some cases the display 180 is part of the detection unit 130 and the user uses the positioning map displayed on the display 180 to transmit and receive data from other mobile device on the positioning map. In some exemplary embodiments of the subject matter, the positioning map is not displayed on the display 180, but is maintained by the mapping unit 140. When the detection unit 130 receives a movement to transmit data, the processor 150 obtains the relative location of a target mobile device from the mapping unit 140 and uses the relative location to transmit the data to the target mobile device. The display 180 may show a list of mobile devices connected to the mobile device 100 and the movement designates one mobile device from the list of mobile devices.

The mobile device 100 comprises a storage 170, which stores transferable and received data stored on the mobile device 100. The storage 170 may store location data of the mobile device 100 and location data of the other mobile devices to which the mobile device 100 is connected. The processor 150 transfers data from the storage 170 to the transceiver 160. The processor 150 receives a command from the detection unit 130 to transfer data stored in the storage 170 to the transceiver 160. The processor 150 transfers to the transceiver 160 the location data of the receiving mobile device so the data being transferred from the storage 170 is transmitted to the correct receiving mobile device. The mobile device 100 may comprise a microphone 175 and a speaker 185 to enable the mobile device to build its positioning map. The microphone 175, the speaker 185, and the transceiver 160 may be used to determine the distances between every two mobile devices by determining the amplitude and time differential of the receiving waves, i.e. radio frequency and audio, to determine the relative location of other mobile devices.

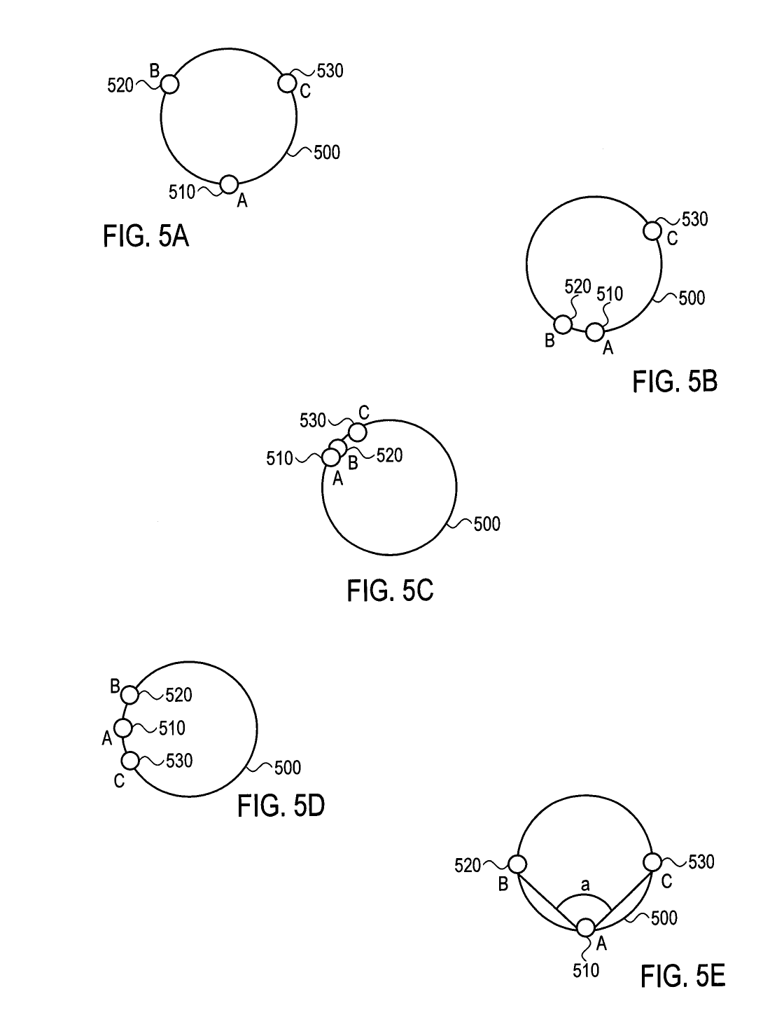

FIG. 2 shows a method performed on two or more mobile devices to generate a positioning map disclosing relative locations of the two or more mobile devices that are directed towards a central region, according to some exemplary embodiments of the subject matter. Step 200 discloses obtaining two or more mobile devices directed towards a central region. The two or more mobile devices are arranged to face at the central region, which enables determining the relative location of the two or more mobile device relative to the central region. In some cases, the central region may be a center of a table where the two or more mobile devices are arranged to face towards the center of the table. In such a case, as detailed in FIGS. 5A-5E, two or more persons sit around the table, in front of the central region, each of the persons is associated with a mobile device of the two or more mobile devices. In other cases, the central region may be the front of a classroom, where the two or more mobile devices are arranged to face towards the front of the classroom.

Step 201 discloses the two or more mobile devices determining a magnetic azimuth value of each mobile device relative to the two or more mobile devices. A mobile device of the two or more mobile devices, such as mobile device 100 of FIG. 1, obtains a three dimensional vector of the magnetic values collected by the magnetometer 120 of FIG. 1. The three dimensional vector comprises of the magnetic values of an x-vector, a y-vector and a z-vector. Step 210 discloses determining device physical orientation. A mobile device determines the mobile device's physical orientation using the three dimensional vectors. The data recorded by the accelerometer 110 enables the processor 150 to determine whether the mobile device 100 is lying on a table top or is held in a different physical orientation, for example at a forty-five degree angle in a user's hand. In cases where the mobile device 100 is held in a user's hand, the mobile device 100 has to determine a rotated vector, by rotating the vectors of the three dimensional vector according to the physical orientation of the mobile device 100. The rotated vector enables obtaining an oriented magnetic azimuth value that is used to determine the relative location of the mobile device 100. For example, when the mobile device 100 is placed on the table top, the mobile device determines orientation according to the x-vector and y-vector, while the z-vector is directed downwards towards the table. Where the mobile device is raised and turned from a lying position and the z-vector is no longer directed down towards the table, the mobile device 100 determines the tilt of the device according to the acceleration and reorients the z-vector to be directed downwards.

Step 220 discloses broadcasting the magnetic azimuth value. The mobile device 100 determines the magnetic azimuth value to determine the relative position of the mobile device 100. The mobile device 100 broadcasts the magnetic azimuth value to a host, which receives magnetic azimuth values from all of mobile devices that are connecting together. In some cases, at least one mobile device of the mobile devices is the host and generates the positioning map. In other cases, all devices transfer and receive information regarding relative positioning and generate the positioning map. The mobile device 100 and the other mobile devices transmit the magnetic azimuth values to at least one mobile device. Step 230 discloses receiving the magnetic azimuth values from the mobile devices. The host or all other mobile devices receive the magnetic azimuth values of the mobile devices. Step 240 discloses generating a positioning map. The mapping unit 140 of FIG. 1 generates the positioning map that maintains and updates the relative locations of the mobile devices connected together. Step 250 discloses displaying the positioning map on the display 180 of FIG. 1. The host broadcasts the positioning map to the mobile device 100, which displays the positioning map on the display 180, to enable the user of the mobile device 100 to view the relative location of the mobile devices. In some cases, all mobile devices of the two or more mobile devices broadcast the positioning map to the mobile device 100.

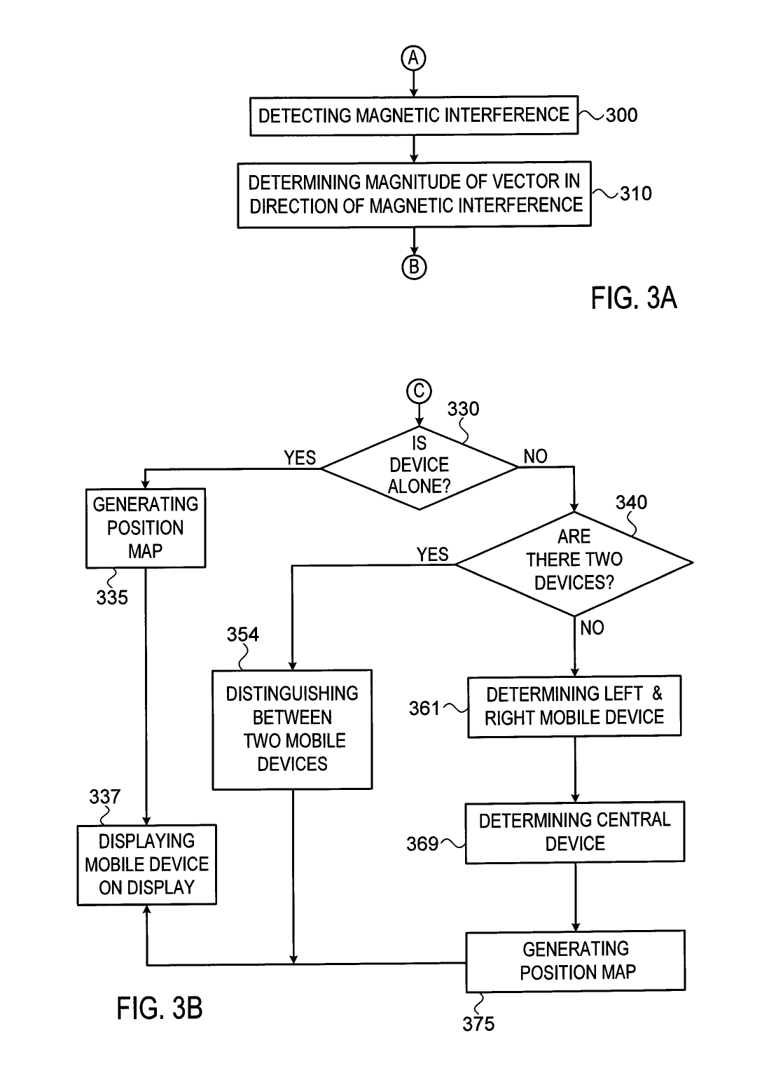

FIG. 3A shows a method performed on a mobile device to determine a magnetic azimuth value of the mobile device where there is magnetic interference, according to some exemplary embodiments of the subject matter. In some cases, the mobile device 100 cannot determine the magnetic azimuth value in step 220 of FIG. 2 due to a magnetic interference from a surrounding area, for example metallic objects located near the mobile device 100. The mobile device 100 performs step 300, which discloses detecting magnetic interference by the magnetometer 120 of FIG. 1. The magnetometer 120 detects interference in obtaining the magnetic azimuth vector. The interference may be caused by a magnet or metallic object located in close vicinity to the mobile device 100. Step 310 discloses determining the magnitude of the vector in a direction of the magnetic interference. Where the magnetic interference occurs on an x vector or a y vector, the magnetometer 120 obtains a new x value and y value of the magnetic azimuth value once the mobile device 100 is moved away from the location of the magnetic interference. Where interference occurs only in the z vector, the mobile device 100 uses the x vector and y vector. The x vector, the y vector and the z vector amount to an absolute value which is a Tesla field of the three vectors. Values of the Tesla field vary between a normalized parameter ranges. Where a spike in the value occurs the mobile device recognizes interference.

FIG. 3B shows a method performed on a mobile device for testing a location threshold of one or more mobile devices, according to some exemplary embodiments of the subject matter. In some cases, two or more mobile devices are configured in a parallel configuration, which prevents determining the relative locations of each mobile device of the two or more mobiles devices. Parallel configuration is defined by two or more mobile devices pointing towards substantially the same azimuth. The same azimuth may include a range of 5-30 degrees difference between the directions of the two or more mobile devices. To solve the parallel issue between the two mobile devices, a mobile device 100 that determines a relative location for each of the two mobile devices separately performs step 330 after step 230 of FIG. 2. Step 330 discloses determining whether a mobile device is alone at a relative location. When the mobile device 100 broadcasts a magnetic value azimuth of the mobile device 100 and no other mobile devices magnetic azimuth value is broadcasted from another mobile device having a parallel configuration, the mobile device 100 continues to step 240 of FIG. 2. Where the mobile device 100 receives more than one broadcast from a parallel configuration the mobile device 100 performs step 340 to determine whether there are only two mobile devices located in parallel configuration. The mobile device 100 recognizes receiving two broadcasted magnetic azimuth values from two mobile devices having the parallel configuration and determines that there are only two devices in the parallel configuration according to the two signals broadcasted from two mobile devices of the two or more mobile devices. In cases where only two mobile devices are located in the parallel configuration, the mobile device 100 performs step 354, which discloses distinguishing between the two mobile devices. The distinguishing can be made for example by broadcasting a message to the two mobile devices to move away from one another. Each mobile device of the two mobile devices is moved in opposite directions, which is detected by an accelerometer of each mobile device. The direction of movement is detected and broadcasted to the mobile device 100, which uses the direction of movement to designate a relative location to each mobile device on a positioning map. In some embodiments of the subject matter, the mobile device 100 may receive images produced by each mobile device of the mobile devices and determine the location of each mobile device according to overlapping areas in the images. In some exemplary embodiments of the subject matter, the mobile device 100 may prompt a user of the mobile device 100 to input the relative location of each mobile device. For example a user command is inputted into the mobile device 100 which of the two mobile devices in parallel configuration is on the left, and which of the two mobile devices in parallel configuration is on the right.

Step 375 discloses generating the positioning map. The mapping unit 140 of FIG. 1 generates the positioning map with relative locations for each mobile device on the positioning map. In some cases, the mapping unit may generate a deviation of the relative location of the each mobile device by several degrees, for example a 10 degree deviation, to create distance on the positioning map between each mobile device of the two mobile devices.

Where there are more than two mobile devices in close vicinity the mobile device 100 broadcasts a request to the more than two mobile devices to create separation or to take an image that may be used to determine the relative location of the two or more mobile devices, similar to step 354. Each mobile device of the two or more mobile devices are broadcasting a movement or the image. The mobile device 100 performs step 361, which discloses determining a left mobile device and a right mobile device. The mobile device 100 determines that the left mobile device is located left of the right mobile device and the right mobile device is right of the left mobile device. The mobile device 100 performs step 369, which discloses designating a central mobile device. Where the mobile device 100 determines the relative locations of the left mobile device and the right mobile device, the mobile device then 100 may determine the central mobile device as a mobile device of the more than two mobile devices located in between the left mobile device and the right mobile device. Step 375 discloses generating the positioning map. The mapping unit 140 of FIG. 1 generates the positioning map with relative locations for each mobile device of the more than two mobile devices on the positioning map. In some cases, the mapping unit may generate a deviation of the relative location of the left mobile device and the right mobile device by several degrees, for example a 10 degree deviation to a left direction or a right direction, to create distance on the positioning map between each mobile device of the more than two mobile devices.

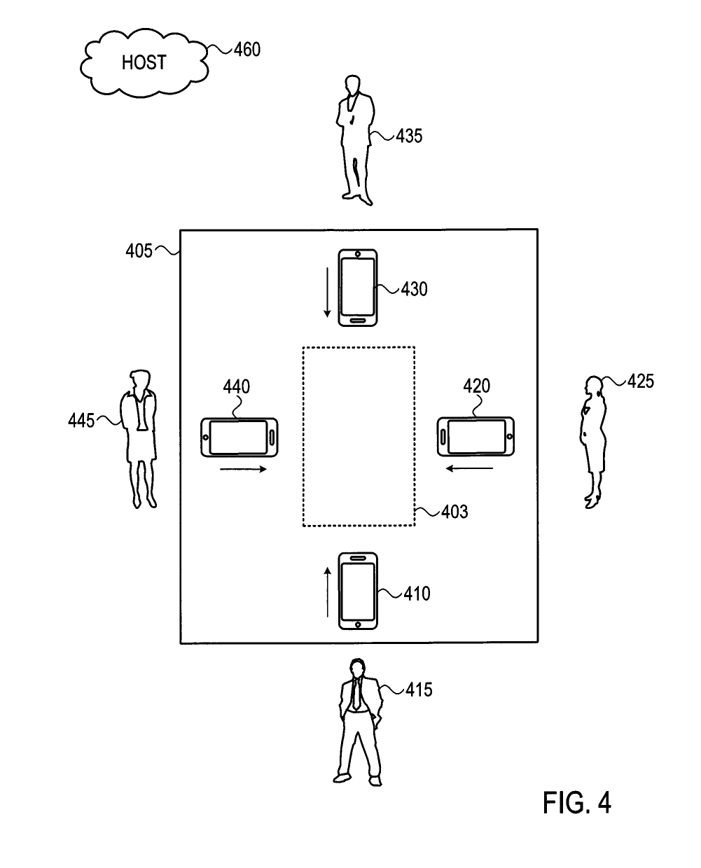

FIG. 4 shows a configuration of mobile devices around a central region, according to some exemplary embodiments of the subject matter. The central region 403 may be located in a center of a table 405. The central region 403 enables mobile devices arranged near the central region 403 to determine relative locations of each other in order to create a positioning map. Four individuals 415, 425, 435, 445 are sitting around the table 405 with four mobile devices, such as first mobile device 410, second mobile device 420, third mobile device 430, and fourth mobile device 440. The four mobile devices are arranged so the four mobile devices are positioned towards the central region 403. The four mobile devices now may determine the relative location of the four mobile devices. Each mobile device of four mobile devices uses a magnetometer, accelerometer or both to determine the relative location according to the central region 403.

In some exemplary embodiments of the subject matter, a host 460 is designated by the four individuals 415, 425, 435, 445 for storing the positioning map. In such cases, the host may be a mobile device of the four mobile devices, a cloud, remote server, a remote mobile device, or the like. Where the host 460 is designated to store the positioning map, the four mobile devices communicate with the host 460 to receive the relative locations to transmit data. The host 460 receives the relative location of the first mobile device 410, the second mobile device 420, the third mobile device 430, and the fourth mobile device 440. After receiving all of the relative locations, the host creates the positioning map and stores it in a storage. In order for one of the four mobile devices to transmit data to another of the four mobile devices, for example, the third mobile device 430 is transmitting data to the second mobile device 420, the third mobile device 430 first requests from the host an identification or address of mobile devices placed in a particular location. The host 460 determines according to the positioning map that mobile device 2 420 is located in a particular location. The host 460 transmits the identification or address of the second mobile device 420 to the third mobile device 430. The third mobile device 430 then transmits the data to the second mobile device 420.

FIG. 5A-5E show configurations of mobile devices on a positioning map, according to some exemplary embodiments of the subject matter. FIG. 5A shows a positioning map with three mobile devices, according to exemplary embodiments of the subject matter. The positioning map 500 comprises of three mobile devices: mobile device A 510, mobile device B 520 and mobile device C 530. The three mobile devices are located at different relative locations on the positioning map. Each mobile device is enabled to broadcast the magnetic azimuth value of the mobile device, which enables the other mobile devices to determine the relative location of the mobile device on the positioning map. For example, mobile device B 520 broadcast's magnetic azimuth value of mobile device B 520 to mobile device A 510 and mobile device C 530. Mobile device A 510 and mobile device C 530 receive the magnetic azimuth value broadcasted by mobile device B 520 and are able to designate the relative location of mobile device B 520 on the positioning map 500.

FIG. 5B shows the positioning map 500 where mobile device A 510 and mobile device B 520 are in parallel configuration, according to some exemplary embodiments of the subject matter. Each mobile device of the three mobile devices broadcasts the magnetic azimuth value. Mobile device C 530 receives the magnetic azimuth value broadcasted by mobile device A 510 and mobile device B 520. Mobile device C 530 attempts to determine the relative locations of mobile device A 510 and mobile device B 520 according to the magnetic azimuth values received from mobile device A 510 and mobile device B 520. Mobile device C 530 determines that mobile device A 510 and mobile device B 520 are in parallel configuration and the relative locations of mobile device A 510 and mobile device B 520 are indiscernible. Mobile device C 530 distinguishes locations of mobile device A 510 and mobile device B 520, for example, by requesting that mobile device A 510 and mobile device B 520 move in opposite directions. Mobile device C 530 receives that mobile device A 510 moves right and mobile device B 520 moves left. Mobile device C 530 distinguishes that mobile device A 510 is to the right and mobile device B 520 is to the left. Mobile device C 530 generates the positioning map 500 showing the relative locations where of mobile device A 510 is on the right and mobile device B 520 is on the left.

FIG. 5C shows the positioning map where mobile device A 510, mobile device B 520, and mobile device C 530 are in parallel configuration, according to some exemplary embodiments of the subject matter. The three mobile devices in FIG. 5C are in parallel configuration, which prevents obtaining relative locations of the three mobile devices for generating the positioning map. Mobile device B 520 is determined to be a central mobile device according to magnetic azimuth values obtained by the three mobile devices. Mobile device B 520 broadcasts a message to mobile device A 510 and mobile device C 530 to move away to enable mobile device B 520 to determine the relative location of mobile device A 510 and mobile device C 530. Once mobile device A 510 and mobile device C 530 receive the message, the users of mobile device A 510 and mobile device C 530 can move the mobile devices away from each other. Once mobile device A 510 and mobile device C 530 are moved away from mobile device B 520, mobile device A 510 and mobile device C 530 determine new magnetic azimuth values and broadcast the new magnetic azimuth values. The new magnetic azimuth values and the magnetic azimuth value of the mobile device B 520 enable determining the relative locations of the three mobile devices and to generate the positioning map.

FIG. 5D shows the positioning map 500 where the three mobile devices are positioned close to one another, according to some exemplary embodiments of the subject matter. Mobile device A 510 is a central mobile device relative to mobile device B 520 and mobile device C 530. In this exemplary embodiment of the subject matter, the three mobile devices are located far enough so each mobile device of the three mobile devices has a unique relative location. The unique relative locations enable creating a positioning map discloses the relative location of each mobile device of the three mobile devices. FIG. 5E shows the positioning map 500, which is relative to mobile device A 510, according some exemplary embodiments of the subject matter. Mobile device A 510 maintains an angle α between mobile device B 520 and mobile device 530.

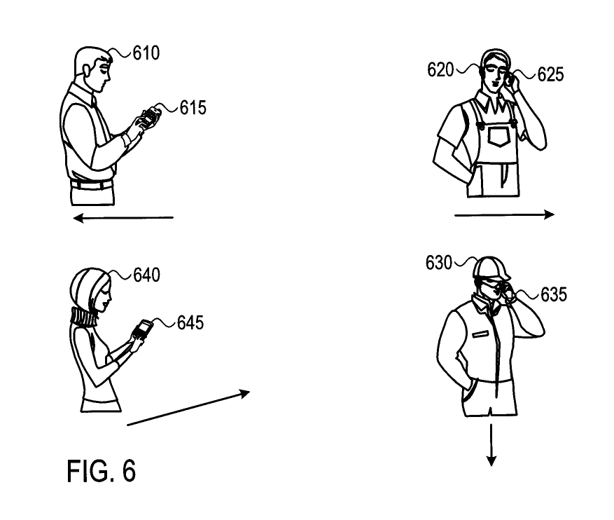

FIG. 6 shows a dynamic configuration of mobile devices, according to exemplary embodiments of the subject matter. In the dynamic configuration users of mobile devices are not facing a central region and may be moving in various directions, which prevents creating a central region between the mobile devices and connecting them in a static configuration. A first person 610 is carrying a first mobile device 615, a second user 620 is carrying a second mobile device 625, a third user 630 is carrying a third mobile device 635 and a fourth user 640 is carrying a fourth mobile device 645. As shown by the arrows, each user is moving in a different direction and is in a different location.

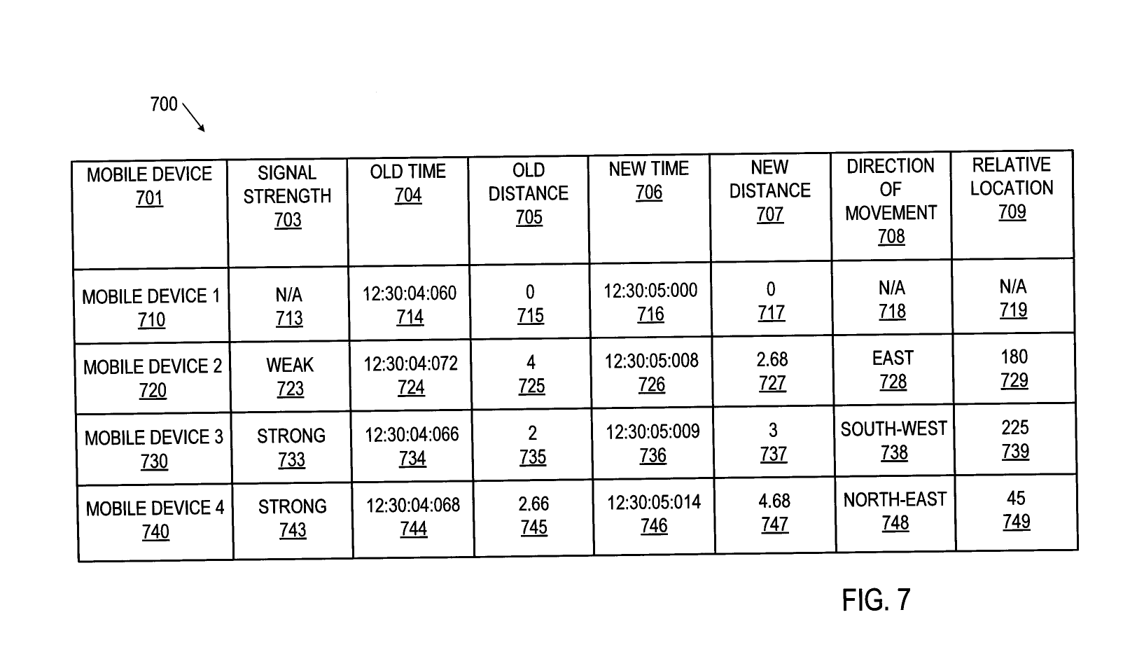

FIG. 7 shows a database on a mobile device for determining relative positions of mobile devices that are dynamic in their movements, according to some exemplary embodiments of the subject matter. The database 700 maintained on the mobile device 100 of FIG. 1 and keeps track of other mobile devices that are connected to the mobile device 100. The database 700 comprises of mobile device designation 701, a signal strength 703, old time 704, old distance 705, new time 706, new distance 707, direction of movement 708, and relative location 709. The mobile device designation 701 lists mobile devices to which the mobile device 100 is connecting. For example the mobile device 100 is connected to mobile device 2 720, mobile device 3 730, and mobile device 4 740. Mobile device 100 is designated as mobile device 1 701, which the mobile device requires for reference data to determine the relative location of the other mobile devices. Mobile device 1 710 transmits a signal at time 12:30:04:060 715 to determine the distance to the other mobile devices. Each of the other mobile devices receives the signal and records the time at which the signal was received. For example, mobile device 2 720 received the signal at time 12:30:04:072 724; mobile device 3 730 received the signal at time 12:03:04:066 734; and mobile device 4 740 received the signal at time 12:03:04:068 744. Each mobile device determines the distance from mobile device 1 710 and broadcasts the distance back to the other mobile devices dynamically connected. For example, mobile device 2 720 broadcasts that a distance of 4 meters 725 from mobile device 1 710; mobile device 3 730 broadcasts that a distance of 2 meters 735 from mobile device 1 710; and mobile device 4 740 broadcasts that a distance of 2.66 meters 745 from mobile device 1 710.

Where the mobile devices move, the mobile device 1 701 broadcasts a second signal at a new time 12:30:05:000 716. Each of the other mobile devices receives the signal and records a direction of movement and time at which the signal was received Mobile device 2 720 moved in an east direction 728 received the signal at time 12:30:05:008 726; mobile device 3 730 moved in an south-west direction 738 and received the signal at time 12:03:04:009 736; and mobile device 4 740 moved in a north-east direction 748 and received the signal at time 12:03:04:014 746. Each mobile device determines the distance from mobile device 1 710 and broadcasts the distance and the direction of movement back to the other mobile devices dynamically connected. Once mobile device 1 710 receives all directions of movement and distances, mobile device 1 710 determines a relative location for each mobile device using the direction of movement and change in distance. For example, the relative location of mobile device 2 720 is 180 degrees 729; the relative location of mobile device 3 730 is 225 degrees 739; and the relative location of mobile device 4 740 is 45 degrees 749.

In some exemplary embodiments of the subject matter, the relative location of each mobile device may be determined by a signal amplitude of the signal when received by each mobile device. The mobile device 1 710 broadcasts the signal and each mobile device records the signal amplitude of the signal. Mobile device 2 720 detects a weak amplitude 723, mobile device 3 730 detects a strong amplitude 733, mobile device 2 740 detects a strong amplitude 723. As each mobile device moves closer or farther from mobile device 1 710 the signal amplitude of the signal increases or decreases respectively. The mobile device 1 710 receives from each mobile device a second signal amplitude of the signal and the direction of motion. The change in the signal amplitude between the signal amplitude and the second signal amplitude, and the direction of movement of each mobile device, enables the mobile device 1 710 to determine the relative location of each mobile device.

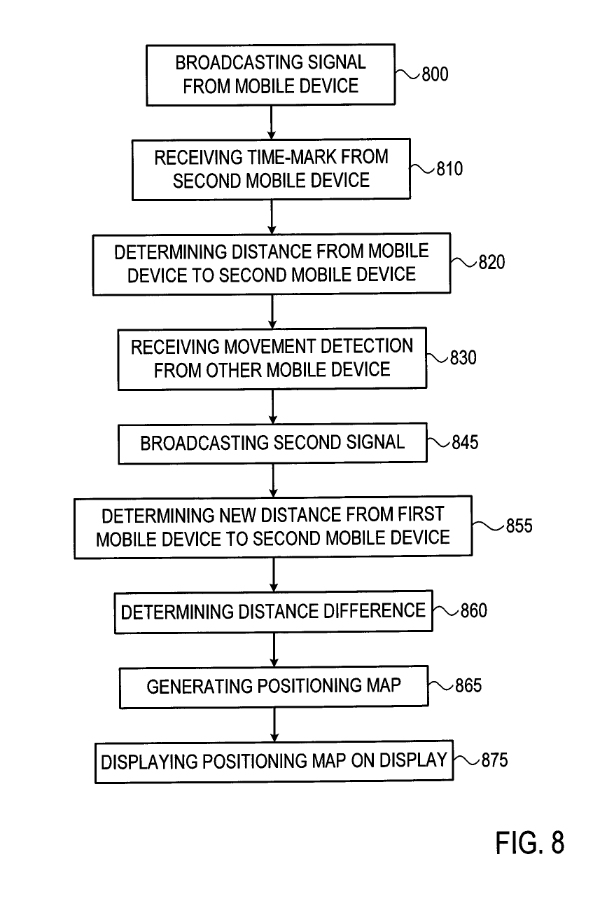

FIG. 8 shows a method performed on two or more mobile devices to generate a positioning map disclosing relative locations of the two or more mobile devices that are moving, according to exemplary embodiments of the subject matter. Step 800 discloses broadcasting a signal from a mobile device of the two or more mobile devices, such as mobile device 100 of FIG. 1. The mobile device 100 broadcasts a signal to other mobile devices of the two or more mobile devices. The signal may be wireless, for example using Wifi. The signal may be broadcasted as an audio signal such that the signal is at a frequency that may be broadcasted from the speaker 185 of FIG. 1. In some cases the audio signal is at an inaudible frequency, which is inaudible to a human ear, but may still be detected by the microphone 175 of FIG. 1. Step 810 discloses receiving a time-mark from other mobile devices of the two or more mobile devices. The other mobile devices receive the signal broadcasted by the mobile device 100. The other mobile devices record the time-mark at which the signal was received and transmit to the mobile device 100 the time-mark. Step 820 discloses determining a distance between the mobile device 100 and a second mobile device of the two or more mobile devices. The mobile device 100 determines the distance to the other mobile devices according to the time required for the signal to travel to the second mobile device, and stores the distance in the database 700 of FIG. 7. Step 830 discloses receiving a movement detection from the second mobile device. When the second mobile device moves the second mobile device transmits a message received by the mobile device 100 informing of the movement and of the movement direction. Step 845 discloses the mobile device 100 broadcasting a second signal to the second mobile device. Step 855 discloses determining a new distance. The mobile device 100 receives from the second mobile device a second time-mark, at which the second mobile device received the second signal. The mobile device determines the new distance to the second mobile device. Step 860 discloses determining a distance difference between the first distance and the second distance. The difference in distance and the movement direction enable the mobile device 100 to determine the second mobile device's relative location. Step 865 discloses generating a positioning map, which comprises of the relative locations of the two or more mobile devices. The positioning map may be updated each time one mobile device of the two or more mobile devices moves. In some exemplary embodiments of the subject matter, the mobile device 100 performs step 875, which discloses displaying the positioning map on the display 180 of FIG. 1. In some exemplary embodiments of the subject matter, the second mobile device detects a first amplitude of the signal transmitted by the mobile device 100 before the second mobile device moves. A second amplitude is detected by the second mobile device after the movement occurs, The relative position is determined by the change of amplitude and the direction of the movement that is collected by the accelerometer.

In some exemplary embodiments of the subject matter, one mobile device of the two or more mobile devices, such as mobile device 100, may determine a global position coordinate using a GPS or manually. The mobile device 100 broadcasts the global position coordinate of the one mobile device to the other mobile devices. Each mobile device of the other mobile devices determines the global positions of each mobile device of the other mobile devices the according to the relative location and the global position of the one mobile device. The one mobile device receives the global positions of the other mobile devices. For example, the one mobile device is located inside a building at a known location, such as in office A. A second mobile device of the two or more mobile devices receives the global position of the one mobile device and determines a second global position according to the relative location of the one mobile device. The second device sends the second global position to the mobile device 100. The mobile device 100 receives the second global position of the second mobile device.

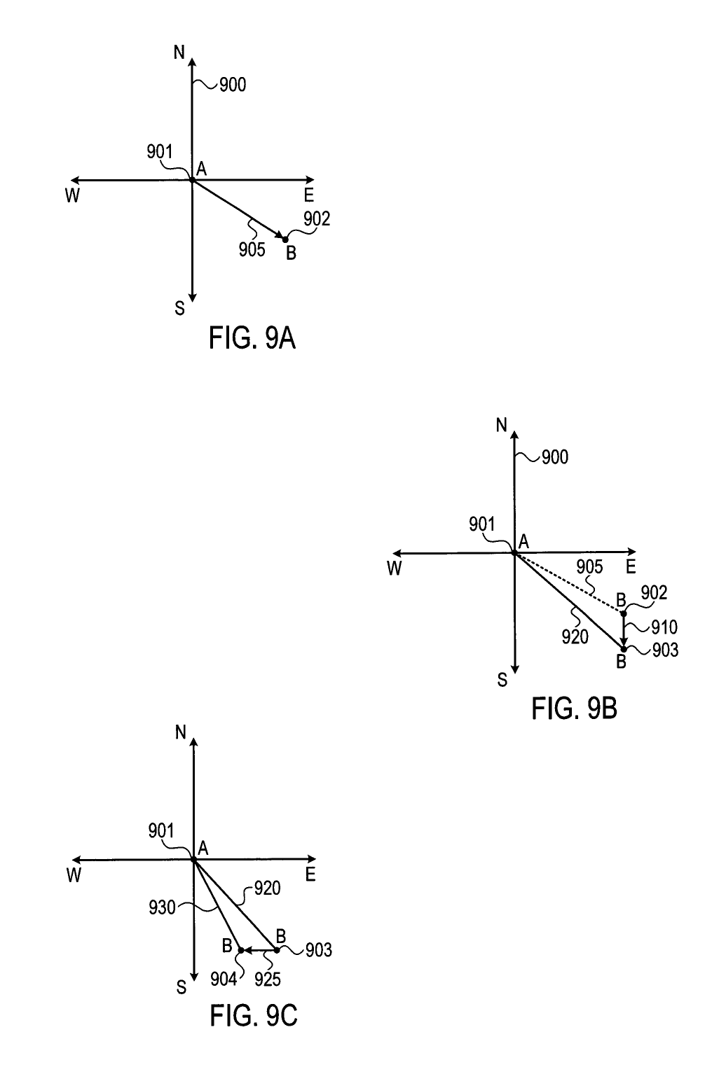

FIGS. 9A-9C shows position data of mobile device B relative to mobile device A on a cardinal points axis system, according to some exemplary embodiments of the subject matter. FIG. 9A shows a mobile device A located at a origin 901 of the cardinal points axis system 900. Mobile device B is located at a first unknown point 902, which is at an unknown distance from the origin 901. The mobile device A broadcasts a signal to the mobile device B, which the mobile device B receives. Then, the mobile device B and broadcasts the time at which the signal was received by the mobile device B. Mobile device A receives the time broadcasted by mobile device B and determines a first distance 905. The first distance 905 may also be determined according to signal strength or other methods desired by person skilled in the art.

FIG. 9B shows the mobile device B moving from the first unknown location 902 in a first direction 910 to a second unknown location 903. The mobile device B broadcasts a signal indicating that the mobile device B has moved. After receiving the signal indicating that the mobile device B has moved, the mobile device A broadcasts a second signal, which is received by mobile device B, to determine whether the distance between the mobile device B and the mobile device A has changed. The mobile device B broadcasts the time at which the second signal was received. Mobile device A determines a second distance 920 between mobile device A and mobile device B at the second unknown location 903. The mobile device A may then determine whether the mobile device B is moving towards or away from the mobile device A. The mobile device B further broadcasts the direction of movement from the second unknown location 903 to the first unknown location 902, for example 66 degrees from the north.

The mobile device A determines the change in distance from the second unknown location 903 to the first unknown location 902. The change in distance and the direction of movement of the mobile device B enable the mobile device A to determine the direction in which mobile device B is located. For example, because the second distance 920 is greater than the first distance, mobile device A determines mobile device B is moving away from mobile device A, which determines that mobile device B is south to mobile device A.

FIG. 9C shows mobile device B performing a third movement from the second unknown location 903 to a third unknown location 904. The mobile device B broadcasts that mobile device B has moved. Mobile device A broadcasts a second signal, which is received by mobile device B. Mobile device B broadcasts the time at which the second signal was received. Mobile device A determines a third distance 930 between mobile device A and mobile device B. Mobile devices A determines the change in distance from the third unknown location to the second unknown location, which enables mobile device A to determine the direction in which mobile device B is located. Mobile device A according to distances and directions obtained that mobile device B is south east to mobile device A.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method performed on two or more mobile devices comprising:
obtaining a magnetic azimuth value of a mobile device of the two or more mobile devices;
obtaining a physical orientation value of the mobile device of the two or more mobile devices;
broadcasting the magnetic azimuth value and the physical orientation value from the mobile device, wherein each mobile device of the two or more mobile devices are broadcasting the magnetic azimuth value and the physical orientation value to another mobile device of the two or more mobile devices;
receiving the magnetic azimuth value and the physical orientation value, wherein each mobile device of the two or more mobile devices receives the magnetic azimuth value and the physical orientation value of other mobile devices of the two or more mobile devices;
determining a relative location of the two or more mobile devices, according to the magnetic azimuth value and the physical orientation value of each mobile device of the two or more mobile devices;
generating a positioning map of the two or more mobile devices, wherein the positioning map comprises relative locations of the two or more mobile devices.

2. The method of claim 1, wherein each mobile device of the two or more mobile devices creates the positioning map and stores the positioning map.

3. The method of claim 1, further comprising:
determining whether two mobile devices of the two or more mobile devices are positioned in parallel configuration when broadcasting position data;
transmitting a message to the two mobile devices that requests the two mobile devices be moved in opposite directions and rebroadcast the position data; and,
updating the positioning map.

4. The method of claim 1, further comprising:
determining whether two mobile devices of the two or more mobile devices are positioned in parallel configuration when broadcasting position data;
receiving an image from each mobile device of the two mobile devices;
determining the relative location according to overlapping portions of images received from the two mobile devices; and,
updating the positioning map.

5. The method of claim 1, further comprising:
determining whether two mobile devices of the two or more mobile devices are positioned in parallel configuration when broadcasting position data;
receiving a user command designating a right mobile device and a left mobile device.

6. The method of claim 1 further comprising:
determining whether three mobile devices are parallel when broadcasting position data;
determining position data of a left mobile device;
determining the position data of a right mobile device;
determining a central mobile device according to the position data of the right mobile device and the left mobile device; and,
updating the positioning map.

7. The method of claim 1 further comprising selecting a host mobile device, wherein all communication between the two or more mobile devices is performed through a host.

8. The method of claim 1, wherein the two or more mobile devices are pointing towards a central region.

9. A method performed on two or more mobile devices comprising:
broadcasting a signal by a mobile device of the two or more mobile devices;
determining a distance between the mobile device and other mobile device of two or more mobile device;
detecting that a second mobile device of the two or more mobile devices performed a movement and a movement direction;
broadcasting a second signal to the second mobile device of the two or more mobile devices;
determining a new distance between the mobile device and other mobile device of the two or more mobile device;
determining a relative location of the second mobile device of the two or more mobile devices, where the relative location is determined by the movement direction and a distance difference between the new distance and the distance;
generating a positioning map, wherein the positioning map comprises relative locations of the two or more mobile devices.

10. The method of claim 9, further comprises:
receiving a time-mark from the second mobile device of the two or more mobile devices, wherein said time-mark is a time the second mobile device of the two or more mobile devices received the signal;
receiving a second time-mark from the second mobile device of the two or more mobile devices, wherein said second time-mark is the time the second mobile device of the two or more mobile devices received the second signal.

11. The method of claim 9, further comprises:
determining a signal amplitude of the signal to determine the distance;
determining a second signal amplitude.

12. The method of claim 9, wherein the method is performed on a host.

13. The method of claim 9, wherein each mobile device of the two or more mobile devices creates the positioning map and stores the positioning map.

14. The method of claim 9, wherein the relative location comprises magnetic azimuth values and proper acceleration values.

15. The method of claim 9, wherein the signal is as an audio signal emitted by a speaker of the mobile device of the two or more mobile devices.

16. The method of claim 9, further comprises:
determining a global position of the mobile device;
broadcasting the global position to other mobile devices;
determining global positions of each mobile device of the other mobile devices, wherein global positions are determined from the relative location and the global position of the mobile device;
receiving global positions from the other mobile devices.

17. A system on a mobile device comprises:
a display;
a detection unit;
a processor to determine a position data of the mobile device, wherein the position data is determined according to a magnetic azimuth value and proper acceleration, wherein the processor determines a physical orientation value of the mobile device;
a mapping unit to create a positioning map according to the position data determined by the processor and the position data received by a transceiver, wherein the position data received by the transceiver is received from other mobile devices;
a storage to store the positioning map created by the mapping unit, wherein the position data is received from the other mobile devices connected to the mobile device.

18. The system of claim 17, wherein the detection unit comprises:
an accelerometer to collect the proper acceleration;
a magnetometer to collect the magnetic azimuth value of the mobile device.

19. The system of claim 17, wherein the display displays the positioning map and threshold of mobile devices connected to the mobile device.

20. The system of claim 17, further comprises:
a speaker to broadcast a signal;
a microphone for collecting the signal broadcasted by the other mobile devices.
